(19) United States
(12) Patent Application Publication
(10) Pub. No.: US 2008/0023553 A1
(43) Pub. Date: Jan. 31, 2008

(54) Optical reader having integral lens and diffuser

(76) Inventor: Robert Jones, Cambridge (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/495,565

(22) Filed: Jul. 31, 2006

(51) Int. Cl. G06K 7/10

(52) U.S. Cl. 235/462.41

(57) ABSTRACT

An optical reader is provided for reading an image provided on a surface. The optical reader has at least one light source and a first lens configured to focus and diffuse light from the at least one light source onto an image. The optical reader also has at least one sensor, and a second lens configured to receive a reflection of the focused and diffused light from the image and direct it to the at least one sensor.

### TECHNICAL FIELD

The present disclosure is directed generally to an optical reader, and more particularly, to an optical reader having an integral lens and diffuser.

### BACKGROUND

Many construction and earthmoving machines use a hydraulic or pneumatic cylinder for moving a work tool such as a bucket, blade, or ripper. The cylinder typically includes a tube and a piston assembly arranged within the tube to form two separate pressure chambers. The chambers are selectively supplied with pressurized fluid and drained of the pressurized fluid to cause the piston assembly to displace within the tube and assist the movement of the work tool. During operation of a machine, it can be important to know the position of the piston relative to the tube so that movement of the work tool can be precisely controlled.

Historically, barcodes have been marked on cylinder pistons to locate the position of the piston relative to the tube. In particular, the piston is etched with non-repeating segments of code, each of which correspond to a different location of the piston relative to the tube. In operation, a sensor is provided within the tube adjacent the barcode to identify a particular segment of the code. One such example is described in pending US Patent Publication No. US2006/0022047 (the publication) by Sewell et al., published Feb. 2, 2006. The publication describes an optical reader which comprises two light emitting diodes (LEDs), two lenses, a diffuser, and an array of photosensors. The LEDs provide light that is received and focused by a lens onto the diffuser. The diffuser spreads and transforms the light into a form that adequately illuminates the bar code. The second lens receives light reflected off of the bar code and focuses it onto the array of photosensors. The photosensors then generate a signal indicative of a position of a piston.

Although this configuration is quite effective for reading the barcode etched on the piston to determine the position of the piston, the utilization of a separate diffuser may be inefficient and burdensome. In particular, a separate diffuser can increase assembly complexity and cost of the reader.

The disclosed optical reader is directed to overcoming one or more of the problems set forth above.

### SUMMARY OF THE INVENTION

In one aspect, the present disclosure is directed toward an optical reader. The optical reader includes at least one light source and a first lens configured to focus and diffuse light from the at least one light source onto an image. The optical reader also includes at least one sensor, and a second lens configured to receive a reflection of the focused and diffused light from the image and direct it to the at least one sensor.

Consistent with a further aspect of the disclosure, a method is also provided for reading an image provided on a surface. The method includes producing light, and simultaneously focusing and diffusing the produced light onto the image. The method also includes focusing a reflection of the diffused light from the image, receiving the focused reflection, and determining a position of the surface based on the received focused reflection.

### BRIEF DESCRIPTION OF THE DRAWINGS

FIG. 1 is a block diagram illustration of an exemplary disclosed positioning system; and

FIG. 2 is a perspective view cross-sectional illustration of an exemplary disclosed reader for use with the positioning system of FIG. 1.

### DETAILED DESCRIPTION

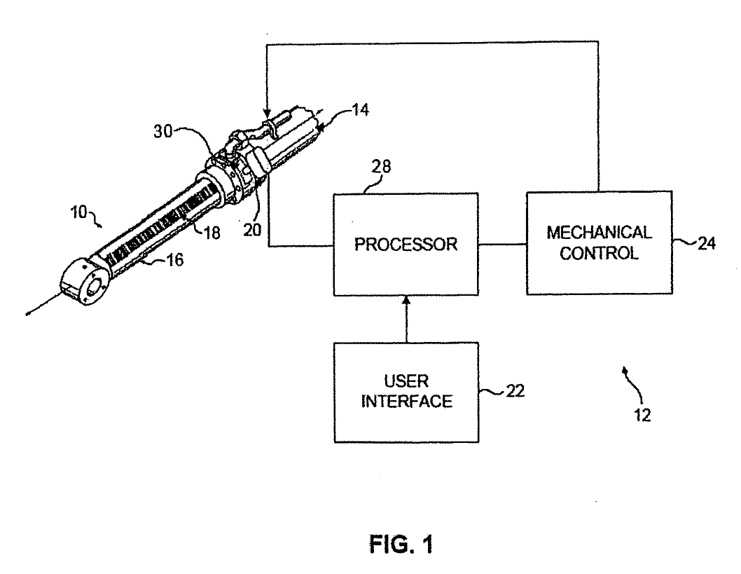

FIG. 1 illustrates a cylinder 10 and a system 12 for monitoring and controlling the expansion and retraction of cylinder 10. The expansion and retraction of cylinder 10 may function to assist the movement of a work tool such as a bucket, blade, or ripper (not shown). For example, cylinder 10 may include a tube 14 operatively connected to the work tool and a piston 16 operatively connected to an associated machine. Piston 16 may be arranged within tube 14 to form two separated pressure chambers (not shown). The pressure chambers may be selectively supplied with pressurized fluid and drained of the pressurized fluid to cause piston 16 to displace within tube 14, thereby changing the effective length of cylinder 10. The expansion and retraction of cylinder 10 may assist in moving the work tool relative to the machine.

Piston 16 may include a conventional thermally sprayed outer surface with a plurality of markings 18 that indicate the position of piston 16 in relation to tube 14. Markings 18 may include, for example, a barcode. It should be understood that markings 18 may be formed by a high intensity laser that selectively exposes portions of the surface to radiation and may represent binary coded information in the sense that the marks, by being dark or light, represent 0s or 1s. In addition, markings 18 may represent encoded information based on numbers calculated with a random number generator, and may be grouped into subsets, each of which may correspond to a particular piston position. It is contemplated that markings 18 may be applied to piston 16 in a manner other than etching, if desired.

System 12 may be used for monitoring and/or controlling the linear movement of piston 16 in relation to tube 14. It should be understood that system 12 may include a reader 20, which may be configured to read markings 18 on the surface of piston 16. Additionally, system 12 may include a user interface 22 configured to transmit data to and receive inputs from a user. Furthermore, system 12 may include a mechanical control 24 for physically controlling the expansion and retraction of cylinder 10. Yet another element that may be included in system 12 is a processor 28 configured to process data received from reader 20 and the user and send commands to mechanical control 24.

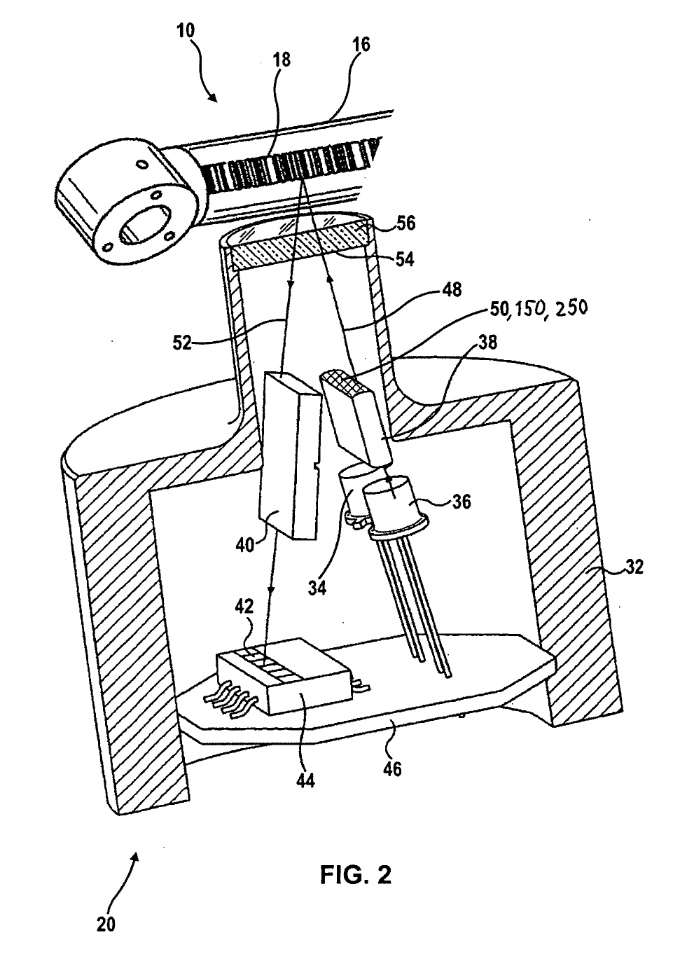

In a disclosed exemplary embodiment, reader 20 may be attached to cylinder 10 through an opening 30 in tube 14. Opening 30 may be sized and shaped in such a manner that when reader 20 is attached to tube 14, the markings 18 that are directly adjacent to reader 20 may be exposed only to light emitted from reader 20. As illustrated in FIG. 2, reader 20 may include a housing 32 enclosing a plurality of optical emitters 34 and 36, a first lens 38, a second lens 40, a sensor 42, a circuit 44, and a support 46.

Optical emitters 34 and 36 maybe used to illuminate the subset of markings 18 by producing light 48. It should be understood that optical emitters 34 and 36 may be any kind of radiation producing sources including, for example, light emitting diodes (LEDs). In addition, light 48 may be produced at any frequency including infrared frequencies. It is contemplated that reader 20 may alternatively include only one LED, if desired.

Light 48 emitted from LEDs 34 and 36 may consist of divergent beams. In this state, the majority of light 48 may not reach markings 18. Lens 38 may control and transform light 48 by bending and focusing the diverging beams in the direction of markings 18. Focusing the beams in the direction of markings 18 may increase the percentage of light 48 that illuminates markings 18. The greater percentage of light 48 reaching markings 18 may increase the radiance value of the light illuminating markings 18, resulting in an increased signal to noise ratio and an increased measurement accuracy of reader 20.

Lens 38 may be manufactured from an acrylic material through, for example, an injection molding process and/or a milling process. In one example, lens 38 may be milled from rod shaped stock. The rod shaped stock may have a diameter of about 15 millimeters and may be milled to produce two opposing flat sides about 3 millimeters apart. The opposing flat sides may provide a means to mount the lens in reader 20 while light 48 may be passed through the cylindrical surfaces that remain unchanged. It should be understood that any number of transparent materials including glass may alternatively be used.

Light 48 may need to be modified before it illuminates markings 18. This is because the surface upon which markings 18 are engraved, may in general, consist of randomly oriented surface imperfections. When illuminated by a non-diffuse wavefront, only imperfections of a specific orientation may specularly reflect light through second lens 40. The specularly reflected light may appear as glints in the image plane of sensor 42. The position of the imperfections reflecting in this manner may vary randomly across the illuminated region and hence create spatially random image noise. The effect may degrade the image formed in the plane at sensor 42 and may reduce the accuracy of reader 20.

The above-mentioned image noise may be significantly suppressed by illuminating markings 18 with a diffuse beam of light. Under these conditions, imperfections on the surface of piston 16 may be illuminated over a range of angles of incidence thereby reducing the orientation specific image noise. This may be accomplished by diffusing focused light 48 as it passes through lens 38. Light 48 may exit lens 38 through a surface 50, which may be modified to create a predetermined angle of divergence, as well as a substantially equal intensity of light 48 over a range of incident angles throughout the entire subset of markings 18. Surface 50 may include one of the unchanged cylindrical surfaces described above. In addition, it should be noted that the use of diffuse illumination may reduce the macroscopic variation in intensity resulting from the variation in the angle of incidence over the illuminated region due to the geometric form of the object. The latter may be a cylindrical surface for the application described.

The angle of divergence is a measure of the spread of light caused by a diffusing surface and is correlated to the range of angles of incidence over which a given portion of the surface is illuminated. To a first order, the suppression of the surface spatial noise (described earlier) increases as this angular range increases. It may also be recognized that as the angle of divergence increases, the area of illumination also increases and the mean radiance of light 48 decreases. It may be important that the latter should not decrease below a level for which sensor 42 is able to effectively detect reflected light 52. Therefore, there may be a tradeoff between the divergence (and hence suppression of surface induced noise) and the signal to noise ratio of the detected bar code signal. In one example, this maximum angle of divergence may be limited to about 30 degrees.

One method used to modify surface 50 may include abrading surface 50. Materials such as acid, sandpaper, or other known scouring tools may be used to abrade surface 50. In order to achieve an accurate reading, the abrasion of surface 50 may need to be substantially consistent. This consistency may be accomplished by requiring that the angle, pattern, depth, and density of cuts resulting from the abrasion process be consistent over the entirety of surface 50. In one example, these homogenous cuts may be made across surface 50 by applying sandpaper having a grit of about 150-600 in a uniform, single direction along the length of surface 50 at a substantially constant pressure for about 10 strokes. A small jig or other machine (not shown) may be used to generate the repetitive motion at the constant pressure.

Physical characteristics of the abrasive material used to modify surface 50 may affect the angle of divergence. For example, as the grit value of the sandpaper increases, the diffusing effect may weaken. This may lead to smaller angles of divergence. A measurement of the roughness of surface 50 may be pre-calibrated against known diffusing angles and may be used to monitor the diffuser manufacturing process. One possible way to measure the roughness of surface 50 might be to utilize a surface gauge (not shown). The surface gauge may measure the center line average (CLA) of depth of the cuts in surface 50.

Another method used to modify surface 50 may include covering surface 50 with a translucent material 150 which may be a layer of polyester film or paper. The diffusion ability of the different translucent materials may be determined by measuring the angle of divergence of light passing through the materials. This measurement may also be useful as an alternative to the CLA measurement described above for determining the preferred roughness of surface 50 when using abrading techniques.

Yet another method alternatively used to modify surface 50 may include employing integral protrusions 250 on surface 50. The protrusions may be created in the same injection molding process used to create lens 38 or through a separate additional process. Just as in the previously described diffuser creating methods, the diffusing ability of surface 50 may require consistency over surface 50. This consistency may be accomplished by manufacturing protrusions having substantially identical shapes and sizes. In addition, the location and spacing between the protrusions may be consistent throughout surface 50.

First lens 38 may transmit light 48 to a subset of markings 18 through an opening 54. It should be noted that opening 54 may be closed by a planar transparent optical window 56 to provide protection for the reader components.

Second lens 40 may receive reflected light 52 from the subset of markings 18 and may focus it onto sensor 42. Lens 40 may be a unitary object manufactured in a manner similar to lens 38, or it may include a prefabricated array of graded index lenses, if desired.

In response to receiving reflected light 52, sensor 42 may generate and transmit a signal to processor 28 (referring to FIG. 1) via circuit 44. It should be understood that sensor 42 may include an array of photosensors, if desired. In one exemplary embodiment, the photosensors may be complementary metal oxide semiconductor (CMOS) photosensors.

User interface 22 may include components that cooperate to display and transmit data. In particular, user interface 22 may include for example, a display or monitor and a keyboard or other data entry device. User interface 22 may display on the monitor, data generated by reader 20 and transmit user-inputted data to processor 28.

Processor 28 may embody a conventional microprocessor, computer, or digital signal processor and include associated circuitry. Processor 28 may be operationally connected to reader 20, user interface 22, and mechanical control 24 to receive and transmit data.

Mechanical control 24 may physically control the extension and retraction of piston 16. Specifically, mechanical control 24 may include an assembly of valves that regulate the flow of pressurized fluids to and from the chambers of cylinder 10. In response to the pressurized fluids, piston 16 may be urged to extend or retract relative to tube 14.

### INDUSTRIAL APPLICABILITY

The disclosed optical reader may provide a simple, inexpensive, and reliable way to determine the position of a moving element. In particular, the disclosed optical reader may utilize a single integral lens/diffuser component to determine the position of a piston relative to a tube housing the piston. The operation of system 12 will now be explained.

Cylinder 10 may be activated to extend or retract a connected machine work tool (not shown) relative to the machine. During the extension or retraction of the connected machine work tool, LEDs 34 and 36 within reader 20 may emit light 48. First lens 38 may bend and focus divergent beams of light 48 as it passes through first lens 38. Substantially simultaneously, as light 48 exits first lens 38, it may pass through modified surface 50 and be diffused. The diffused light 48 may pass through opening 54 of reader 20 and uniformly illuminate a subset of markings 18.

Light 52 reflected off of the subset of markings 18, may pass through opening 54 of reader 20 and into lens 40. Lens 40 may then focus light 52 onto sensor 42. Once sensor 42 receives reflected light 52, it may generate a signal indicative of the subset of markings 18 that were illuminated by light 48 and transmit the signal to processor 28 via circuit 44. In response to the signal, processor 28 may determine a position of piston 16 and display the determined position on user interface 22. In response to commands inputted to the processor 28 from user interface 22 and the identified position, processor 28 may supply control signals to mechanical control 24, to thereby move piston 16.

Because the focusing and diffusing functions of optical reader 20 may be performed substantially simultaneously by a single modified lens, the number of components and the size of optical reader 20 may be reduced. In addition, the reduction of the number of components within optical reader 20 may decrease assembly complexity and associated cost and unreliability.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. An optical reader comprising:
at least one light source;
a first lens configured to focus and diffuse light from the at least one light source onto an image;
at least one sensor; and
a second lens configured to receive a reflection of the focused and diffused light from the image and direct the reflection to the at least one sensor.

2. The optical reader of claim 1, wherein the image includes a barcode.

3. The optical reader of claim 1, wherein the first lens includes a cylindrical surface through which light passes.

4. The optical reader of claim 3, wherein a diffusion ability of the cylindrical surface is achieved through a roughening of the cylindrical surface.

5. The optical reader of claim 4, wherein the cylindrical surface includes indentations throughout the cylindrical surface.

6. The optical reader of claim 4, wherein the cylindrical surface includes protrusions throughout the cylindrical surface.

7. The optical reader of claim 3, wherein the cylindrical surface is covered with a translucent material.

8. The optical reader of claim 7, wherein the translucent material is a polyester film.

9. The optical reader of claim 7, wherein the translucent material is paper.

10. The optical reader of claim 1, wherein the first lens is fabricated from an acrylic material.

11. The optical reader of claim 1, wherein the at least one light source includes a light emitting diode.

12. A method for reading an image provided on a surface comprising:
producing light;
simultaneously focusing and diffusing the produced light onto the image;
focusing a reflection of the diffused light from the image;
receiving the focused reflection; and
determining a position of the surface based on the received focused reflection.

13. The method of claim 12, wherein the steps of focusing and diffusing are accomplished by directing the produced light through a lens having a roughened surface.

14. The method of claim 12, wherein the steps of focusing and diffusing are accomplished by directing the produced light through a surface coated with a polyester film.

15. The method of claim 12, wherein the steps of focusing and diffusing are accomplished by directing the produced light through a surface covered with a sheet of paper.

16. A position sensing system comprising:
a housing;
a piston reciprocatingly disposed within the housing and having a surface with a barcode etched therein;
an optical reader disposed within the housing and configured to sense a position of the piston relative to the housing, the optical reader including:
at least one light emitting diode;
a first lens configured to focus and diffuse light from the at least one light emitting diode onto the barcode;
at least one photosensor;
a second lens configured to receive a reflection of the focused and diffused light from the barcode and direct the reflection to the at least one photosensor; and
a processor in communication with the at least one photosensor and configured to determine the position of the piston relative to the housing based on a signal from the at least one photosensor.

17. The system of claim 16, wherein a surface of the first lens through which light passes is cylindrical.

18. The system of claim 17, wherein a diffusion ability of the cylindrical surface is achieved through a roughening of the cylindrical surface.

19. The system of claim 16, wherein the roughened surface includes at least one of indentations and protrusions.

20. The system of claim 19, wherein the cylindrical surface is covered with a translucent material.
